(19) United States
(12) Patent Application Publication
(10) Pub. No.: US 2024/0319934 A1
(43) Pub. Date: Sep. 26, 2024

(54) METHOD AND APPARATUS FOR PREDICTING MAINTENANCE REQUIREMENTS OF A PRINTING DEVICE

(71) Applicant: CEBURU STSTEMS, INC., Santa Rosa, CA (US)

(72) Inventors: Jaseem MASOOD, Petaluma, CA (US); Rehan KHAN, SW Ranches, FL (US)

(21) Appl. No.: 18/124,557

(22) Filed: Mar. 21, 2023

Related U.S. Application Data
(63) Continuation of application No. 18/124,556, filed on Mar. 21, 2023.
Application No. 18/124,556 is a continuation of application No. 18/124,557, filed on Mar. 21, 2023.

(51) Int. Cl. G06F 3/12

(52) U.S. Cl. CPC G06F 3/1217; G06F 3/1235

(57) ABSTRACT

A method and apparatus for predicting maintenance requirements of a printing device includes a method comprising receiving performance parameters from multiple printers at a performance analysis server (PAS), and generating a printer status based on the parameters using an AI engine. The printer status includes printer identifier, performance state of the printer, and the parameter causing the state. The method determines a probability of a performance event for the printer occurring at a future time interval based on the printer status, wherein the performance event includes issues with printer service due to depletion of consumables used therein. The method further predicts, using the AI engine, a time interval for occurrence of the performance event, based on the probability and the performance parameters.

### CROSS-REFERENCE TO RELATED APPLICATIONS

This application claims the benefit of a U.S. Patent Application, titled “METHOD AND APPARATUS FOR PREDICTING FAILURE IN A NETWORKED ENVIRONMENT,” having an attorney docket no. CEB001, filed on even date herewith, and incorporated by reference in its entirety.

### FIELD

The present invention relates to monitoring devices communicably coupled over a network, and more specifically to predicting maintenance requirements of a device from multiple communicably coupled devices, for example, printers, scanners, computers and other.

### BACKGROUND

Today's computing deployments are increasingly complex and include a large number of nodes, for example, devices or hardware entities, software entities, communication and other resources. Often, such nodes experience performance issues or events, including degradation or failure due to transient or persistent issues, or performance states. Occurrence of such performance events can lead to deterioration of service for customers using services or functionality of the nodes, damage to the nodes experiencing the performance events, issues with other nodes in the network, and several others, as known in the art. Similarly, various devices may face service issues due depletion of consumables, and/or maintenance and/or service needs. Conventional solutions have generally been deficient in terms of accuracy, coverage, and timeliness in identifying such events proactively, and causes thereof.

Accordingly, there is a need in the art for method and apparatus for predicting maintenance requirements of a printing device.

### SUMMARY

The present invention provides a method and an apparatus for predicting maintenance requirements of a printing device, substantially as shown in and/or described in connection with at least one of the figures, as set forth more completely in the claims. These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

So that the manner in which the above-recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts an apparatus for predicting failure in a customer environment, in accordance with an embodiment.

FIG. 2 depicts a flow diagram of a method for predicting failure in a customer environment, in accordance with an embodiment.

FIG. 3 depicts an apparatus for predicting a maintenance requirement of a printer, in accordance with an embodiment.

FIG. 4 depicts a flow diagram of a method for predicting a maintenance requirement of a printer, in accordance with an embodiment.

### DETAILED DESCRIPTION

Embodiments of the present invention relate to a method and an apparatus for predicting failure in a customer environment, such as, a computing environment with several nodes, of which at least some nodes are communicably coupled or networked, including multiple nodes or communicably coupled via a network, for example, computing environments of enterprises, including, but not limited, on-premise deployments, cloud deployments, hybrid deployments, among others. In particular, the disclosed techniques include monitoring all performance parameters in the network, for example, by recording and sending, or streaming such parameters corresponding to each node, and apply an artificial intelligence (AI) and/or machine learning (ML) models (“model(s) or AI model(s)”) to determine a status of a node with different than expected performance, for example, degradation, failure, or unexpected increase, and a cause or potential cause therefor.

Further, the techniques include determining a probability of an undesirable performance event for the node at a time in the future, based on the status of the node, and optionally, the performance parameters. Additionally, the probability is used by an AI model and performance parameters to predict an occurrence of a performance event for the node in the future, for example, performance degradation or failure of the node, or another node or service in the customer environment.

In some embodiments, the method includes generating recommendations to avoid the occurrence of the undesirable performance event (e.g., failure) at the node, to isolate the node, to retire the node gracefully, or to perform such or other known mitigating actions based on a user input or automatically.

Some embodiments of the present invention relate to a method and apparatus for predicting maintenance requirements of devices that use consumables, such as a printer, and are capable of being communicably coupled to a network. For example, printing devices or systems in a home and/or a facility, in multiple homes and/or facilities, in network environments of a single organization, in network environments of multiple organizations, or any combinations thereof, as known in the art. In particular, the disclosed techniques include monitoring all performance parameters of all the printers, for example, by recording and sending, or streaming such parameters corresponding to each printer, and apply an artificial intelligence (AI) and/or machine learning (ML) models (“model(s) or AI model(s)”) to determine a status of a printer with different than expected performance, for example, low ink levels, and a state/cause or potential state/cause therefor.

Further, the techniques include determining a probability of an undesirable performance event for the printer at a time in the future, based on the status of the printer, and optionally, the performance parameters. Additionally, the probability is used by an AI model and performance parameters to predict an occurrence of a performance event for the printer in the future, for example, performance degradation of the printing service or failure of the printing service of the printer.

In some embodiments, the method includes generating recommendations to avoid the occurrence of the undesirable performance event (e.g., ink depletion) at the printer, or to perform mitigating actions based on a user input or automatically.

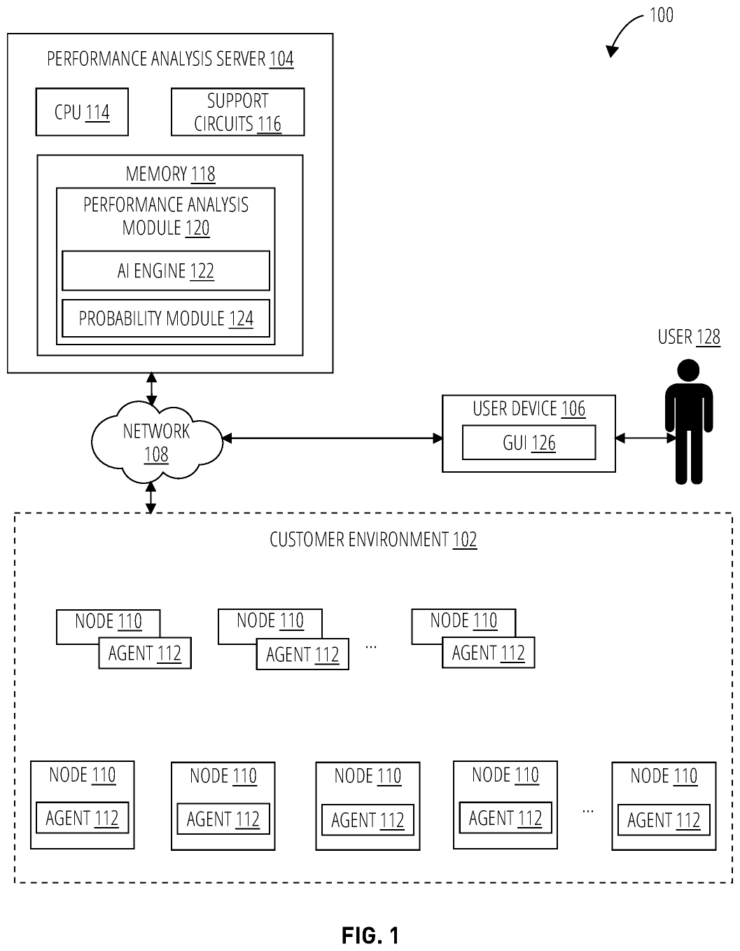

FIG. 1 depicts an apparatus 100 for predicting failure in a customer environment, in accordance with an embodiment. The apparatus 100 includes a customer environment 102, a user device 106, a performance analytics server (PAS) 104 or server 104, and a network 108 communicably coupling the customer environment 102, the user device 106 and the PAS 104.

The customer environment 102 includes multiple nodes 110, each individually referred to as a node 110. The nodes 110 of the customer environment 102 are communicably coupled via a network (not shown), and include devices (hardware entities) and software-based entities, and other known entities used in networks or computing environments. The nodes include computers, routers, switches, firewalls, servers, hubs, repeaters, virtual machines, containers, printers, scanners, internet of thing (IoT) devices, and the like, deployed in configurations as known in the art. The performance parameters or performance logs of the node 110 relate to any of its hardware components, software components, communication, or an external component such as third party services or devices, and such performance logs or performance parameters may also include logs for communication over one or more of hardware layers, software layers or transport layer according to the open systems interconnection (OSI) model. In some embodiments, the performance parameters include information for all the seven layers of the OSI model. Scanning all seven layers ensures that all performance logs or performance parameters (all issues) from all seven layers are considered in the analysis using the present techniques, and enables identifying any issues in any of the seven layers.

Each node 110 includes or is associated with an agent 112, and each node 110 and associated agent 112 is identifiable by an identifier or an ID. For example, nodes that are hardware devices or virtual machines may include an agent 112 installed thereon, while other node entities may have an agent 112 associated therewith using known techniques. The agent 112 is configured record performance parameters for the node, and send the performance parameters, for example, to the PAS 104. The agent 112 is also configured to respond to queries for performance parameter information from the PAS 104. In some embodiments, the agent 112 sends the performance parameters continuously, such as, via streaming. In some embodiments, the agent 112 sends the responses one or more of instantaneously, periodically, upon caching a particular quantity of data, or any combination thereof. The performance parameters for a node include one or more of time, location, activity, utilization, network traffic, network bandwidth, network configuration, subnet configuration, manufacturing specifications, or physical conditions of or at the node, such as temperature, humidity, pressure, air flow, and the like. The customer environment 102 further includes a probe, which a master node in the customer environment 102. The probe is configured to scan and discover nodes 110, deploy agents 112 for all nodes 110, and further, collect information from all agents 112 to transmit to the PAS 104, for example, to the performance analysis module 120. In some embodiments, one or more of the agents 112 is configured to include the functionality of the probe.

In some embodiments, the nodes 110 of the customer environment 102 are communicably coupled via communication channels known in the art separate from the network 108. In some embodiments, the nodes 110 are communicably coupled via the network 108. In some embodiments, some of the nodes 110 are communicably coupled via the communication channels, and some of the nodes 110 are communicably coupled via the network 108. In some embodiments, the nodes 110 are not a part of the customer environment 102, and instead are individually communicably coupled via the network 108.

The PAS 104 includes a CPU 114 communicatively coupled to support circuits 116 and a memory 118. The CPU 114 may be any commercially available processor, microprocessor, microcontroller, and the like. The support circuits 116 comprise well-known circuits that provide functionality to the CPU 114, such as, a user interface, clock circuits, network communications, cache, power supplies, I/O circuits, and the like. The memory 118 is any form of digital storage used for storing data and executable software, which are executable by the CPU 114. Such memory 118 includes, but is not limited to, random access memory, read only memory, disk storage, optical storage, various non-transitory storages known in the art, and the like. The memory 118 includes computer readable instructions corresponding to an operating system and other routine functions (not shown), and a performance analysis module 120, which includes an AI engine 122, and a probability module 124. In some embodiments, the PAS 104 is deployed in the cloud. In some embodiments, the PAS 104 is deployed in an enterprise owner's environment, such as, enterprise cloud, enterprise premises, and the like, for example, in the customer environment 102.

The performance analysis module 120 is configured to identify a node displaying an unusual performance, such as degraded performance or failure, cause thereof, predict such unusual performance and cause thereof, and either based on an instruction or automatically, mitigate the unusual performance identified or predicted. The performance analysis module 120 receives the identifiers and the performance parameters of the nodes 110 from the agents 112, for example, via the network 108. The performance parameters for multiple nodes 110 are fed to the AI engine 122, which identifies a node, for example, via the identifier thereof, from multiple nodes 110, and the node 110 is experiencing an unusual (degraded, failed, or otherwise aberrant) performance state. The AI engine 122 also identifies the unusual performance state, and a performance parameter of the identified node, or a performance parameter of another node causing the unusual performance state, together referred to as the status of the node experiencing the unusual performance state. For example, the AI engine 122 may identify a status for a router node, an identifier of the router, such as an IP address, or a MAC address, or a combination thereof, the performance state that the bandwidth of the connection to a connected device to the router (which may be a node) is low, and the performance parameter causing the low bandwidth as the temperature, which is higher than is considered optimal. The performance analysis module 120 may send the status to an administrator of the customer environment 102, for example, the user 128, via the network 108, for display on the GUI 126 of the user device 106.

The status of the node generated by the AI engine 122 is used by the probability module 124 to compute a probability of occurrence of a performance event for the node, such as a failure of the node, degradation of the service at the node or provided by the node, or a potential of harm to another node, at a given future time interval. In some embodiments, the probability module 124 further uses one or more of the historical status data or performance parameters causing the performance state for the same node, or for the same performance state of the node, for computing the probability. In the router example, the probability module 124 uses the low bandwidth performance state, high temperature as the cause of the low bandwidth, and computes, for a particular time interval in the future, a probability of occurrence of a performance event, such as degradation of service of the router, failure of the router, potential of harm to a network storage device (not shown), and the like. The probability module 124 may also take into consideration the historical statuses and/or temperature parameter of the router, or only those historical statuses of the router in which the temperature was high, to compute the probability. In some embodiments, the probability module 124 computes the probability for several future time intervals, and identifies a time interval for which the probability meets or exceeds a threshold probability score.

The probability data generated by the probability module 124, for example, all probability scores, or only the probability scores meeting or exceeding the threshold, is provided to the AI engine 122. Based on the probability data for a given node, and the performance parameters of the nodes received from the customer environment 102, the AI engine 122 predicts the performance event for the given node or another node, the performance parameter at cause for the performance event, in a time interval or a specific time in the future. The time interval predicted by the AI engine 122 may be the same as or different from the time intervals considered by the probability module 124 for generating the probability scores. In the router example, the AI engine 122 may predict that for the router (identified using the identifier) the overall router performance will degrade below a predefined performance threshold (performance event), between 75 hours to 78 hours from now, due to the high temperature (performance state).

The performance analysis module 120 sends this information, viz., the router identifier, the performance event (performance degradation), the performance state at cause (high temperature), and the predicted time interval for the performance event (75 hours to 78 hours from now), to the administrator of the customer environment 102, so that mitigation actions may be taken. In some embodiments, the performance analysis module 120 is configured to perform mitigation actions, either based on receiving an input from the administrator, for example, from the user device 106, via the network, or automatically based on pre-configured rules. Mitigation actions include, without limitation, creating a backup of the node or a functionality thereof, isolating the node, or shutting down the node.

The AI engine 122 includes one or more artificial intelligence and/or machine learning (AI) models, such as an identifier AI model and a prediction AI model, each of which may further include multiple AI models.

In some embodiments, the identifier AI model is trained using training data including performance parameters from the nodes 110, and labels including the node identifier, performance state and performance parameter causing the performance state. Such training data is validated, for example, by humans, rule based algorithms or other known techniques. In some embodiments, the identifier AI model is trained using supervised learning, unsupervised learning, reinforcement learning and other learning techniques as known in the art. In some embodiments, the identifier AI model is trained to identify the status of a node based on the performance parameters for all nodes, all available nodes (in case some nodes are unavailable), or multiple nodes (less than all available nodes) of the customer environment 102. The trained identifier AI model of the AI engine 122 generates the status of a node from the performance parameters, as discussed above.

In some embodiments, the prediction AI model is trained using training data including the probability score for a node from probability module 124, optionally the performance parameters from the nodes 110, and labels including performance state for the node and the time at which the performance state occurred. Such training data is validated, for example, by humans, rule based algorithms or other known techniques. In some embodiments, the prediction AI model is trained using supervised learning, unsupervised learning, reinforcement learning and other learning techniques as known in the art. In some embodiments, the prediction AI model is trained based on the performance parameters for all nodes, or all available nodes (in case some nodes are unavailable), or multiple nodes (less than all available nodes) of the customer environment 102. The trained prediction AI model of the AI engine 122 generates the time interval for a performance event for a node, as discussed above. Various thresholds discussed herein can be predefined, for example, by a user, determined by the AI engine 122, or be redefined by the AI engine 122. The AI engine 122 is configured to learn over time as the AI engine 122 receives more data on the nodes 110 of the customer environment 102, and all performance events or issues, failures of the nodes. Over time, with this enhanced learning, the AI engine 122 becomes more accurate and faster in predicting when a node or an associated entity or resource will degrade and/or fail.

The probability module 124 is configured to compute a probability of occurrence of a performance event for the node for one or more future time intervals, based on the status of the node. In some embodiments, the probability module 124 computes the probability based further on one or more of all historical status data for the node, only the historical status data for the node having the same performance parameter at cause as that identified by the identifier AI model, or all or some historical data of the performance parameter at cause identified by the identifier AI model. The probability module 124 utilizes any known probability function or functions to compute the probability of occurrence of the performance event for the node, including but not limited to, normal distribution, Bernoulli distribution, uniform distribution, binomial distribution, Poisson distribution, exponential distribution, among others known in the art.

The user device 106 is a computing device as known in the art accessible to a user 128, such as an administrator of the customer environment 102. The user device 106 includes a GUI 126 configured to display information and receive instructions from the user 128. In some embodiments, the user device 106 is a node 110 of the customer environment 102. In some embodiments, the user device 106 is a device outside of the customer environment 102, and is configured to send and receive information over the network 108.

The network 108 is a communication network, such as any of the several communication networks known in the art, and for example a packet data switching network such as the Internet, a proprietary network, a wireless GSM network, among others. The network 108 is capable of communicating data to and from the customer environment 102, nodes 110 therein, the PAS 104 and the user device 106.

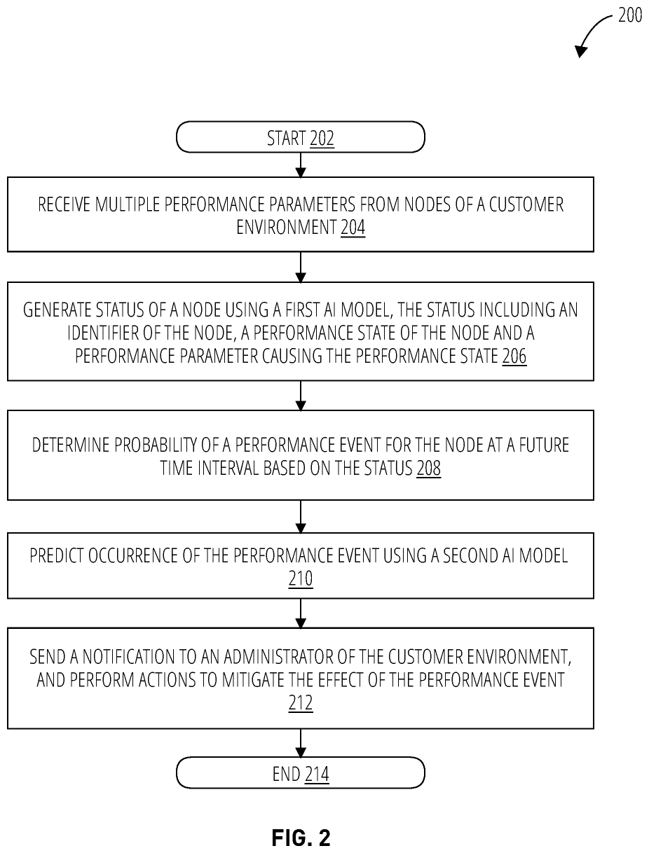

FIG. 2 depicts a flow diagram of a method 200 for predicting failure in a customer environment, for example, the customer environment 102 of FIG. 1, in accordance with an embodiment. In some embodiments, the performance analysis module 120 of the PAS 104 performs the method 200.

The method 200 starts at step 202, and step 204, the method 200 receives multiple performance parameters from nodes of a customer environment, for example, nodes 110 of the customer environment 102. The performance parameters may be sent by the corresponding agents 112 resident on or associated with the nodes 110, to the performance analysis module 120, upon request or without request from the performance analysis module 120.

At step 206, the method 200 generates status of a node, for example, using a first AI model of the AI engine 122, such as the identifier AI model. As discussed above, the status generated by the AI engine 122 includes an identifier of the node, a performance state of the node, and a performance parameter causing the performance state.

At step 208, the method 200 includes determining probability of a performance event for the node at a future time interval based on the status, for example, using the probability module 124, as discussed above. In some embodiments, the probability is determined based further on one or more of all historical status data for the node, only the historical status data for the node having the same performance parameter at cause as that identified at step 206, or all or some historical data of the performance parameter at cause identified at step 206.

At step 210, the method 200 predicts occurrence of the performance event, for example, using a second AI model of the AI engine 122, such as the prediction model. As discussed above, the prediction AI model predicts the occurrence of the performance event and time interval or a specific time for the occurrence of the performance event, for a node.

At step 212, the method 200 performs an action including sending a notification to an administrator (user) of the customer environment, for example, to the user device 106 via the network 108 for display on the GUI 126. If the user sends an instruction to the effect, or automatically, the method 200 performs one or more actions to mitigate the effect of the performance event of the node, for example, creating a backup of the node or a functionality thereof, isolating the node, or shutting down the node.

The method 200 proceeds to step 214, at which the method 200 ends.

Although the example method 200 depicts a particular sequence of operations, the sequence may be altered without departing from the scope of the present disclosure. For example, some of the operations depicted may be performed in parallel or in a different sequence that does not materially affect the function of the method 200. In other examples, different components of an example device or system that implements the method 200 may perform functions at substantially the same time or in a specific sequence.

Further, while two separate AI models have been discussed for ease of explanation, a single composite AI model can be used to provide the functionalities of the two AI models described herein, and such configurations are contemplated herein.

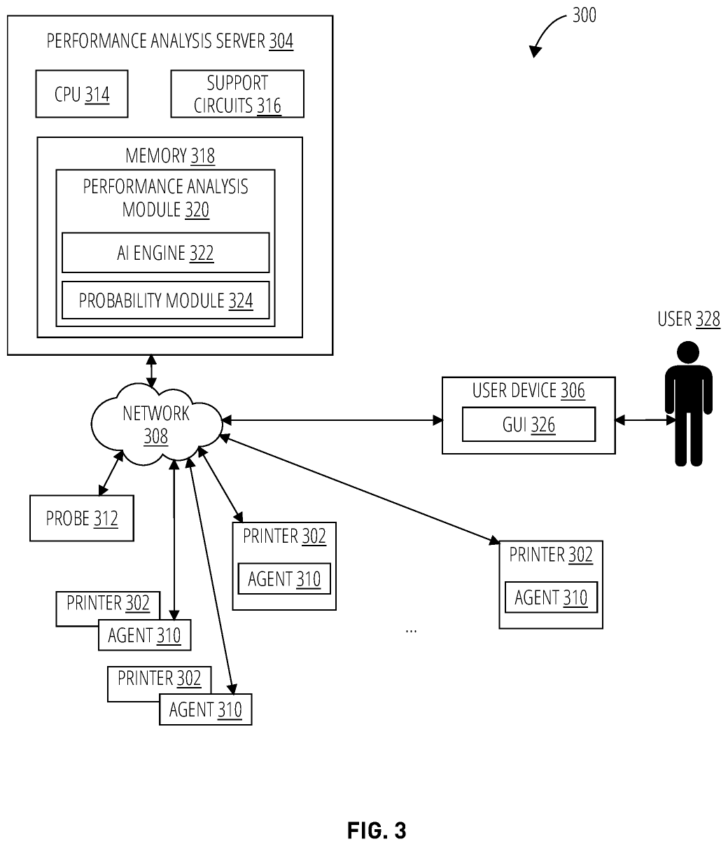

FIG. 3 depicts an apparatus 300 for predicting a maintenance requirement of a printer, in accordance with an embodiment. The apparatus 300 includes multiple printers 302, a performance analytics server (PAS) 304 or server 304, a user device 306, and a network 308 communicably coupling the printers 302, the user device 306 and the PAS 304.

The printers 302 have multiple printers 302, each individually referred to as a printer 302. The printers 302 include devices such as those deployed in offices, shops, homes or other facilities, and require to be serviced from time to time for replenishing consumables. In case of printers 302, the consumables include ink or toners, sheets of paper, staple pins or other binding devices that may be used in the regular operation of the printer.

The performance logs and/or performance parameters of the printers 302 relates to any of its hardware components, software components, communication, or an external component such as third party services or devices, and such performance or performance parameters may also relate to communication over one or more of hardware layers, software layers or transport layer according to the open systems interconnection (OSI) model. In some embodiments, the performance parameters include performance log information for all the seven layers of the OSI model. Scanning all seven layers ensures that all performance logs or performance parameters (all issues) from all seven layers are considered in the analysis using the present techniques, and enables identifying any issues in any of the seven layers.

Each printer 302 has an agent 310 installed thereon or an agent 310 associated therewith, and each printer 302 and associated agent 310 is identifiable by an identifier or an ID. For example, printers 302 that have capacity to have an agent be installed thereon, may include an agent 310 installed thereon. Some printers 302 may not have capacity for installation of agents, for example, a printer may not have a firmware that permits installation of an agent, may lack available memory/storage for installation and/or operation of the agent 310, or for any other reason. Each such printer 302 is associated with an agent 310 installed on another device communicably coupled to such printer 302, and configured to monitor the performance parameters of the printer 302. The agent 310 is configured record performance parameters for the printer 302, and send the performance parameters, for example, to the PAS 304. The agent 310 is also configured to respond to queries for performance parameter information from the PAS 304. In some embodiments, the agent 310 sends the performance parameters continuously, such as, via streaming. In some embodiments, the agent 310 sends the responses one or more of instantaneously, periodically, upon caching a particular quantity of data, or any combination thereof. The performance parameters for a printer 302 include one or more of time, location, print activity, ink utilization, manufacturing specifications, or physical conditions of or at the printer, such as temperature, humidity, pressure, air flow, and the like. The apparatus 300 may further include one or more probes, configured to scan and discover the printers 302, for example, in a specified network destination, such a particular printer or a network, having multiple printers therein, accessible via the network 308. The probe is configured to deploy agents 310 for all printers or function as the agent for the printers, and further, collect information from all agents 310 or printers 302 to transmit to the PAS 304, for example, to the performance analysis module 320. In some embodiments, one (or more) of the agents 310 may include functionality of the probe.

In some embodiments, some or all of the printers 302 are communicably coupled via communication channels known in the art, separate from the network 308. In some embodiments, some of the printers 302 are communicably coupled via the communication channels, and some of the printer 302 are communicably coupled via the network 308. For example, some printers may be deployed in an organization's network, across one or more geographically separated facilities, some printers may be deployed in another organization's network, across one or more geographically separated facilities, one or more printers may be deployed in a network (organizational or individual homes or facilities), or directly connected to the network 308. In some embodiments, different probes may be deployed for different group of printers, as may be efficient, or schemes otherwise known in the art.

The PAS 304 includes a CPU 314 communicatively coupled to support circuits 316 and a memory 318. The CPU 314 may be any commercially available processor, microprocessor, microcontroller, and the like. The support circuits 316 comprise well-known circuits that provide functionality to the CPU 314, such as, a user interface, clock circuits, network communications, cache, power supplies, I/O circuits, and the like. The memory 318 is any form of digital storage used for storing data and executable software, which are executable by the CPU 314. Such memory 318 includes, but is not limited to, random access memory, read only memory, disk storage, optical storage, various non-transitory storages known in the art, and the like. The memory 318 includes computer readable instructions corresponding to an operating system and other routine functions (not shown), and a performance analysis module 320, which includes an AI engine 322, and a probability module 324. In some embodiments, the PAS 304 is deployed in the cloud. In some embodiments, the PAS 304 is deployed in an enterprise owner's environment, such as, enterprise cloud, enterprise premises, and the like.

The performance analysis module 320 is configured to identify a printer 302 that needs servicing due to consumable(s) being exhausted, which particular consumable(s) need servicing, predict such servicing needs and cause thereof, and either based on an instruction or automatically, perform or schedule a service call for the service need identified or predicted. The performance analysis module 320 receives the identifiers and the performance parameters of the printers 302 from the agents 310, for example, via the network 308. The performance parameters for multiple printers 302 are fed to the AI engine 322, which identifies a printer 302, for example, via the identifier thereof, from multiple printers 302, where the identified printer 302 is experiencing a service need (consumables depleted, or otherwise unavailable, and need replenishment, replacement or servicing). The AI engine 322 also identifies the specific servicing need or performance state, for example, ink level low, and a performance parameter of the identified printer, for example, ink level at 22%, together referred to as the status of the printer 302 experiencing the service need (performance state). In some embodiments, the performance parameter includes additional information, such as how many sheets of paper can be printed in the ink that is remaining, for example, 22% ink level may correspond to printing ability on 60-65 sheets of paper. In some embodiments, such dependence of one consumable (ink or toner) in terms of other consumable(s) (sheets of paper) may be determined using known relationships, or be determined using an AI model, including the AI models discussed herein, trained accordingly. The performance analysis module 320 may send the status to an administrator of the printers 302, for example, the user 328, via the network 308, for display on the GUI 326 of the user device 306.

The status of the printer generated by the AI engine 322 is used by the probability module 324 to compute a probability of occurrence of a performance event for the printer, such as a exhaustion or low level of a consumable at the printer, at a given future time interval. In some embodiments, the probability module 324 further uses one or more of the historical status data or performance parameters causing the performance state for the same printer, or for the same performance state of the printer, for computing the probability. In the ink level low example discussed above, the probability module 324 uses the low ink level as performance state, 22% ink remaining as cause of the low ink level, and computes, for a particular time interval in the future, a probability of occurrence of a performance event, such as degradation of printing ability of the printer, inability of the printer to print, and the like. The probability module 324 may also take into consideration the historical statuses and/or ink levels of the printer, or only those historical statuses of the printer in which the ink was low, to compute the probability. In some embodiments, the probability module 324 computes the probability for several future time intervals, and identifies a time interval for which the probability meets or exceeds a threshold probability score.

The probability data generated by the probability module 324, for example, all probability scores, or only the probability scores meeting or exceeding the threshold, is provided to the AI engine 322. Based on the probability data for a given printer, and the performance parameters of the printers received therefrom, the AI engine 322 predicts the performance event for the given printer, the performance parameter at cause for the performance event, in a time interval or a specific time in the future. The time interval predicted by the AI engine 322 may be the same as or different from the time intervals considered by the probability module 324 for generating the probability scores. In the ink level low example, the AI engine 322 may predict that for the printer (identified using the identifier) the printer ink level will deplete below a predefined performance threshold (performance event), between 75 hours to 78 hours from now or between 60-65 sheets of paper of print, due to the current low ink level (performance state).

The performance analysis module 320 sends this information, viz., the printer identifier, the performance event (ink level low), the performance state at cause (ink level 22%), and the predicted time interval for the performance event (75 hours to 78 hours from now), to the administrator of the printers 302, so that mitigation actions may be taken. In some embodiments, the performance analysis module 320 is configured to perform mitigation actions, either based on receiving an input from the administrator, for example, from the user device 306, via the network 308, or automatically based on pre-configured rules. Mitigation actions include, without limitation, scheduling a service to replenish the consumable, order the consumable, scheduling a shut down of the printer, or shutting down the printer. In some embodiments, the mitigation actions are taken based on performance state satisfying a predefined threshold. For example, mitigation action is taken if 4 days or less ink life remaining, or less than 50 sheets of paper work of ink remaining. It is understood that such threshold may rely on various effects of performance parameters on the consumable, for example, even though some ink or toner may be remaining, long duration since the last print, or high temperature at the printer may cause the ink or toner to dry out and become unusable. In some embodiments, the AI models are configured to adjust or generate thresholds based on observed behavior, which may embody such knowledge of performance parameters on consumables.

The AI engine 322 includes one or more artificial intelligence and/or machine learning (AI) models, such as an identifier AI model and a prediction AI model, each of which may further include multiple AI models.

In some embodiments, the identifier AI model is trained using training data including performance parameters from the printer 302, and labels including the printer identifier, performance state and performance parameter causing the performance state. Such training data is validated, for example, by humans, rule based algorithms or other known techniques. In some embodiments, the identifier AI model is trained using supervised learning, unsupervised learning, reinforcement learning and other learning techniques as known in the art. In some embodiments, the identifier AI model is trained to identify the status of a node based on the performance parameters for all printer 302, all available printers (in case some printers are unavailable), or multiple printers (less than all available nodes). The trained identifier AI model of the AI engine 322 generates the status of a printer from the performance parameters, as discussed above.

In some embodiments, the prediction AI model is trained using training data including the probability score for a printer from probability module 324, optionally the performance parameters from the printers 302, and labels including performance state for the printer and the time at which the performance state occurred. Such training data is validated, for example, by humans, rule based algorithms or other known techniques. In some embodiments, the prediction AI model is trained using supervised learning, unsupervised learning, reinforcement learning and other learning techniques as known in the art. In some embodiments, the prediction AI model is trained based on the performance parameters for all printers, or all available printers (in case some printers are unavailable), or multiple printers (less than all available nodes). The trained prediction AI model of the AI engine 322 generates the time interval for a performance event for a printer, as discussed above. Various thresholds discussed herein can be predefined, for example, by a user, determined by the AI engine 322, or be redefined by the AI engine 322. The AI engine 322 is configured to learn over time as the AI engine 322 receives more data on the printers 302, and all performance events or issues of the service needs of the printers. Over time, with this enhanced learning, the AI engine 322 becomes more accurate and faster in predicting when a printer consumable will cause degraded service and/or a service failure. Further, while two separate AI models have been discussed for ease of explanation, a single composite AI model can be used to provide the functionalities of the two AI models described herein, and such reconfigurations are contemplated herein.

The probability module 324 is configured to compute a probability of occurrence of a performance event for the printer for one or more future time intervals, based on the status of the printer. In some embodiments, the probability module 324 computes the probability based further on one or more of all historical status data for the printer, only the historical status data for the printer having the same performance parameter at cause as that identified by the identifier AI model, or all or some historical data of the performance parameter at cause identified by the identifier AI model. The probability module 324 utilizes any known probability function or functions to compute the probability of occurrence of the performance event for the printer, including but not limited to, normal distribution, Bernoulli distribution, uniform distribution, binomial distribution, Poisson distribution, exponential distribution, among others known in the art.

The user device 306 is a computing device as known in the art accessible to a user 328, such as an administrator of the printers 302. The user device 306 includes a GUI 326 configured to display information and receive instructions from the user 328.

The network 308 is a communication network, such as any of the several communication networks known in the art, and for example a packet data switching network such as the Internet, a proprietary network, a wireless GSM network, among others. The network 308 is capable of communicating data to and from the printers 302, probe 312, the PAS 304 and the user device 306.

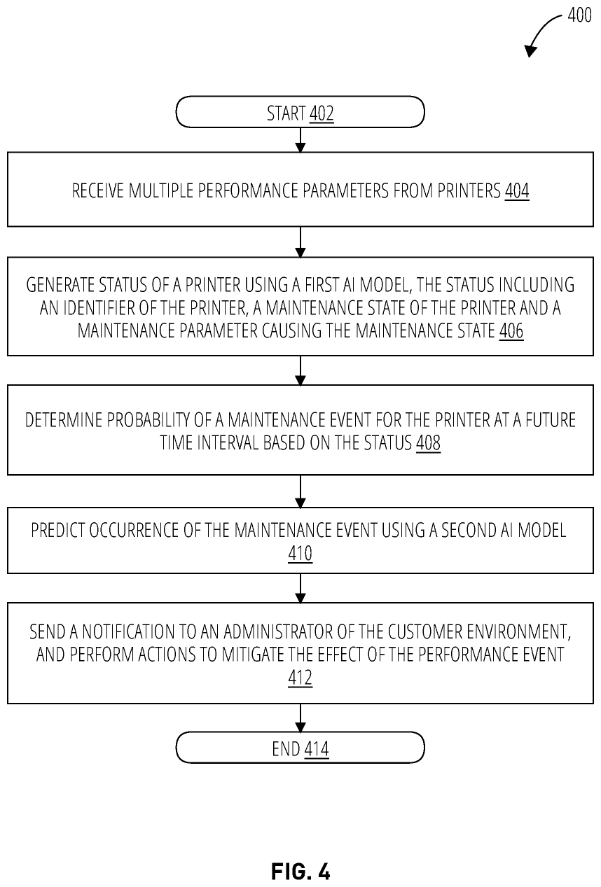

FIG. 4 depicts a flow diagram of a method 400 for predicting a maintenance requirement of a printer, for example, one or more of the printers 302 of FIG. 3, in accordance with an embodiment.

The method 400 starts at step 402, and step 404, the method 400 receives multiple performance parameters from printers, for example, printers 302. The performance parameters may be sent by the corresponding agents 310 resident on or associated with the printer 302, to the performance analysis module 320, upon request or without request from the performance analysis module 320.

At step 406, the method 400 generates status of a printer, for example, using a first AI model of the AI engine 322, such as the identifier AI model. As discussed above, the status generated by the AI engine 322 includes an identifier of the printer, a performance state of the printer, and a performance parameter causing the performance state of the printer.

At step 408, the method 400 includes determining probability of a performance event for the printer at a future time interval based on the status, for example, using the probability module 324, as discussed above. In some embodiments, the probability is determined based further on one or more of all historical status data for the printer, only the historical status data for the printer having the same performance parameter at cause as that identified at step 406, or all or some historical data of the performance parameter at cause identified at step 406.

At step 410, the method 400 predicts occurrence of the performance event, for example, using a second AI model of the AI engine 322, such as the prediction model. As discussed above, the prediction AI model predicts the occurrence of the performance event and time interval or a specific time for the occurrence of the performance event, for a printer.

At step 412, the method 400 performs an action including sending a notification to an administrator (user) of the printers, for example, to the user device 306 via the network 308 for display on the GUI 326. If the user sends an instruction to the effect, or automatically, the method 400 performs one or more actions to mitigate the effect of the performance event of the printer, for example, scheduling a service to replenish the consumable, order the consumable, scheduling a shut down of the printer, or shutting down the printer.

The method 400 proceeds to step 414, at which the method 400 ends.

Although the example method 400 depicts a particular sequence of operations, the sequence may be altered without departing from the scope of the present disclosure. For example, some of the operations depicted may be performed in parallel or in a different sequence that does not materially affect the function of the method 400. In other examples, different components of an example device or system that implements the method 400 may perform functions at substantially the same time or in a specific sequence.

Further, while two separate AI models have been discussed for ease of explanation, a single composite AI model can be used to provide the functionalities of the two AI models described herein, and such configurations are contemplated herein. Furthermore, it is appreciated here that while the embodiments discussed herein with respect to FIGS. 3 and 4 describe the techniques in context of printers 302, however, such techniques are applicable to any devices that can be communicably coupled via network, and require servicing for replenishing consumables, and all such embodiments are contemplated herein.

The foregoing describes techniques disclosed herein with respect nodes 110 in a network, for example, customer environment 102 (FIGS. 1 and 2), or nodes without a networked customer environment 102, to identify and predict a performance event, cause thereof and a time for the performance event. Other embodiments that may similarly utilize the described techniques include devices such as computers (laptops, tablets, desktops, smartphones), printers, scanners, smart cameras, IoT devices, televisions, and other devices capable of monitoring status of hardware, software, communications, and other services thereon, and being communicably coupled, for example, transportation devices, such as cars, trucks, airplanes, ships, among several others that would occur to those skilled in the art. For example, in embodiments in a car capable of monitoring on or more of its own performance parameters, such as engine oil level, engine heating, vehicle skidding information (as used for anti-lock braking system (ABS) activation), its graphical user interface stability, self-driving systems parameters, and other such parameters, including receiving such performance parameters for a car, and predicting a performance event, for example, engine failure, tire balding, software crash, and the like, and a time or time interval for such an event, and optionally, taking mitigation actions, in accordance with the techniques discussed herein. The foregoing also describes techniques disclosed herein with respect printers 302 (FIGS. 3 and 4), communicably coupled over a network, some of which may be a part of a networked customer environment, to identify and predict a performance event, cause thereof and a time for the performance event. Other embodiments that may similarly utilize the described techniques include devices requiring consumables, capable of monitoring status of the consumable and related services thereon, and being communicably coupled, for example, 3D printers having the consumables such as printing filament, connected HVAC or refrigeration systems having the consumable such as filters, other IoT devices having consumables, among several others that would occur to those skilled in the art.

The methods described herein may be implemented in software, hardware, or a combination thereof, in different embodiments. In addition, the order of steps in methods can be changed, and various elements may be added, reordered, combined, omitted or otherwise modified. All examples described herein are presented in a non-limiting manner. Various modifications and changes can be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances can be provided for components described herein as a single instance. Boundaries between various components, operations and data stores are somewhat arbitrary, and particular operations are illustrated in the context of specific illustrative configurations. Other allocations of functionality are envisioned and can fall within the scope of claims that follow. Structures and functionality presented as discrete components in the example configurations can be implemented as a combined structure or component. These and other variations, modifications, additions, and improvements can fall within the scope of embodiments as defined in the claims that follow.

In the foregoing description, numerous specific details, examples, and scenarios are set forth in order to provide a more thorough understanding of the present disclosure. It will be appreciated, however, that embodiments of the disclosure can be practiced without such specific details. Further, such examples and scenarios are provided for illustration, and are not intended to limit the disclosure in any way. Those of ordinary skill in the art, with the included descriptions, should be able to implement appropriate functionality without undue experimentation.

References in the specification to “an embodiment,” and the like, indicate that the embodiment described can include a particular feature, structure, or characteristic, but every embodiment may not necessarily include the particular feature, structure, or characteristic. Such phrases are not necessarily referring to the same embodiment. Further, when a particular feature, structure, or characteristic is described in connection with an embodiment, it is believed to be within the knowledge of one skilled in the art to affect such feature, structure, or characteristic in connection with other embodiments whether or not explicitly indicated.

Embodiments in accordance with the disclosure can be implemented in hardware, firmware, software, or any combination thereof. Embodiments can also be implemented as instructions stored using one or more machine-readable media, which may be read and executed by one or more processors. A machine-readable medium can include any mechanism for storing or transmitting information in a form readable by a machine (e.g., a computing platform or a “virtual machine” running on one or more computing platforms). For example, a machine-readable medium can include any suitable form of volatile or non-volatile memory.

In addition, the various operations, processes, and methods disclosed herein can be embodied in a machine-readable medium and/or a machine accessible medium/storage device compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium/storage device.

Modules, data structures, and the like defined herein are defined as such for ease of discussion and are not intended to imply that any specific implementation details are required. For example, any of the described modules and/or data structures can be combined or divided into sub-modules, sub-processes or other units of computer code or data as can be required by a particular design or implementation.

In the drawings, specific arrangements or orderings of schematic elements can be shown for ease of description. However, the specific ordering or arrangement of such elements is not meant to imply that a particular order or sequence of processing, or separation of processes, is required in all embodiments. In general, schematic elements used to represent instruction blocks or modules can be implemented using any suitable form of machine-readable instruction, and each such instruction can be implemented using any suitable programming language, library, application-programming interface (API), and/or other software development tools or frameworks. Similarly, schematic elements used to represent data or information can be implemented using any suitable electronic arrangement or data structure. Further, some connections, relationships or associations between elements can be simplified or not shown in the drawings so as not to obscure the disclosure.

This disclosure is to be considered as exemplary and not restrictive in character, and all changes and modifications that come within the guidelines of the disclosure are desired to be protected. Other technical features may be readily apparent to one skilled in the art from the following figures, descriptions, and claims.

1. A computer implemented method for predicting maintenance requirements of printers, the method comprising:
receiving, at a performance analysis server (PAS), from a plurality of printers, a plurality of performance parameters for each of the plurality of printers; and
generating, using an artificial intelligence and/or machine learning (AI) engine, based on the plurality of performance parameters, a status for a printer from the plurality of printers, the status comprising
at least an identifier of the printer,
a performance state of the printer, and
at least one performance parameter from the plurality of performance parameters causing the performance state;
determining, based on the status of the printer, a probability of occurrence of a performance event for the printer in a first time interval in the future, wherein the performance event comprises at least one of an exhaustion of a consumable, or a reduction of the amount of the consumable causing a performance degradation of the printer; and
generating, using the AI engine, based on the probability and the plurality of performance parameters, a prediction of the performance event in a second time interval in the future, wherein the first time interval is the same as or different from the second time interval.

2. (canceled)

3. (canceled)

4. (canceled)

5. The computer implemented method of claim 1, further comprising sending, from the PAS to a user device, a notification comprising at least one of the status of the printer, the prediction, or a proposed action to mitigate the performance event.

6. The computer implemented method of claim 1, further comprising performing, by the PAS, automatically or in response to an instruction from the user device, at least one of scheduling a service to replenish the consumable, order the consumable, scheduling a shut down of the printer, or shutting down the printer.

7. The computer implemented method of claim 1, wherein each of the plurality of performance parameters are received automatically from the plurality of printers, or in response to a query sent to at least one of the plurality of printers.

8. The computer implemented method of claim 1, wherein each of the plurality of performance parameters comprises at least one of time, location, activity, utilization, or amount of consumable remaining at each printer.

9. The computer implemented method of claim 1, wherein the AI engine is trained on performance parameters of the plurality of printers.

10. The computer implemented method of claim 1, wherein the receiving comprises receiving the plurality of performance parameters from at least one of a plurality of agents, each associated with corresponding each of the plurality of printers, or a probe associated with each of the plurality of printers.

11. A computing apparatus comprising:
a processor; and
a memory storing instructions that, when executed by the processor, configure the apparatus to:
receive, at a performance analysis server (PAS), from a plurality of printers, a plurality of performance parameters for each of the plurality of printers;
generate, using an artificial intelligence and/or machine learning (AI) engine, based on the plurality of performance parameters, a status for a printer from the plurality of printers, the status comprising
at least an identifier of the printer,
a performance state of the printer, and
at least one performance parameter from the plurality of performance parameters cause the performance state;
determine, based on the status of the printer, a probability of occurrence of a performance event for the printer in a first time interval in the future, wherein the performance event comprises at least one of an exhaustion of a consumable, or a reduction of the amount of the consumable causing a performance degradation of the printer; and
generate, using the AI engine, based on the probability and the plurality of performance parameters, a prediction of the performance event in a second time interval in the future, wherein the first time interval is the same as or different from the second time interval.

12. (canceled)

13. (canceled)

14. (canceled)

15. The computing apparatus of claim 1, wherein the instructions further configure the apparatus to send, from the PAS to a user device, a notification comprising at least one of the status of the printer, the prediction, or a proposed action to mitigate the performance event.

16. The computing apparatus of claim 1, wherein the instructions further configure the apparatus to perform, by the PAS, automatically or in response to an instruction from the user device, at least one of scheduling a service to replenish the consumable, order the consumable, scheduling a shut down of the printer, or shutting down the printer.

17. The computing apparatus of claim 11, wherein each of the plurality of performance parameters are received automatically from the plurality of printers, or in response to a query sent to at least one of the plurality of printers.

18. The computing apparatus of claim 11, wherein each of the plurality of performance parameters comprises at least one of time, location, activity, utilization, or amount of consumable remain at each printer.

19. The computing apparatus of claim 11, wherein the AI engine is trained on performance parameters of the plurality of printers.

20. The computing apparatus of claim 11, wherein the receive comprises receiving the plurality of performance parameters from at least one of a plurality of agents, each associated with corresponding each of the plurality of printers, or a probe associated with each of the plurality of printers.

21. A non-transitory computer-readable storage medium, the computer-readable storage medium including instructions that when executed by a computer, cause the computer to:
receive, at a performance analysis server (PAS), from a plurality of printers, a plurality of performance parameters for each of the plurality of printers;
generate, using an artificial intelligence and/or machine learning (AI) engine, based on the plurality of performance parameters, a status for a printer from the plurality of printers, the status comprising
at least an identifier of the printer,
a performance state of the printer, and
at least one performance parameter from the plurality of performance parameters causing the performance state;
determine, based on the status of the printer, a probability of occurrence of a performance event for the printer in a first time interval in the future, wherein the performance event comprises at least one of an exhaustion of a consumable, or a reduction of the amount of the consumable causing a performance degradation of the printer; and
generate, using the AI engine, based on the probability and the plurality of performance parameters, a prediction of the performance event in a second time interval in the future, wherein the first time interval is the same as or different from the second time interval.

22. The computer-readable storage medium of claim 21, wherein the instructions further configure the computer to send, from the PAS to a user device, a notification comprising at least one of the status of the printer, the prediction, or a proposed action to mitigate the performance event.

23. The computer-readable storage medium of claim 21, wherein the instructions further configure the computer to perform, by the PAS, automatically or in response to an instruction from the user device, at least one of scheduling a service to replenish the consumable, order the consumable, scheduling a shut down of the printer, or shutting down the printer.

24. The computer-readable storage medium of claim 21, wherein each of the plurality of performance parameters are received automatically from the plurality of printers, or in response to a query sent to at least one of the plurality of printers.

25. The computer-readable storage medium of claim 21, wherein each of the plurality of performance parameters comprises at least one of time, location, activity, utilization, or amount of consumable remaining at each printer.

26. The computer-readable storage medium of claim 21, wherein the AI engine is trained on performance parameters of the plurality of printers.
